(19) United States
(12) Patent Application Publication
(10) Pub. No.: US 2019/0202096 A1
(43) Pub. Date: Jul. 4, 2019

(54) DEVICE AND PROCESS FOR PRODUCING HYBRID COMPOSITE PARTS

(71) Applicant: SABIC GLOBAL TECHNOLOGIES B.V., Bergen op Zoom (NL)

(72) Inventors: Kylie Speirs, Pittsfield, MA (US); Somasekhar Bobba Venkat, East Greenbush, NY (US); Raghavendra Janiwarad, Bangalore (IN); Craig Lawrence Milne, Pittsfield, MA (US); Rn Ashwin Kumar, Bangalore (IN)

(21) Appl. No.: 16/323,044

(22) PCT Filed: Aug. 3, 2017
(86) PCT No.: PCT/US2017/045258

§ 371 Date: Feb. 4, 2019

(30) Foreign Application Priority Data
Aug. 4, 2016 (IN) 201611026593

(51) Int. Cl. B29C 45/14; B29C 45/73

(52) U.S. Cl. CPC B29C 45/14073; B29C 45/14786; B29K 2105/0872; B29C 45/73; B29C 2045/1409; B29C 45/1418

(57) ABSTRACT

A molding process and device produce a hybrid composite part. The process includes configuring a mold cavity (102) to receive a prepreg material (116), configuring the mold cavity further to receive an injection of material, and providing a mold core (104) including at least one main core (112). The at least one main core (112) are configured to move with respect to the mold core (104). The process includes moving the mold core (104) with respect to the mold cavity (102) with a first actuator mechanism, moving the mold core to take a first configuration, forming with the mold core in the first configuration a preform from the prepreg material, moving the mold core to take a second configuration, and over molding onto the preform with the injection of the material with the mold core in the second configuration.

### FIELD OF THE DISCLOSURE

This disclosure relates to a process for producing hybrid composite parts, and further to a device for producing hybrid composite parts.

### BACKGROUND OF THE DISCLOSURE

One conventional way of producing hybrid (composite+plastic) parts is shown in FIG. 11. In stage one, a laminate 1201 will typically be produced and the laminate 1201 will typically be heated and formed in a second stage forming device 1203 to create a preform 1205, such as the exemplary C section preform 1205 shown in FIG. 11. The preform 1205 may be inserted into a mold 1207 to create an over-molded composite plastic hybrid part 1209. The conventional process needs at least three stages and multiple forming structures to produce the final part 1209 as shown in FIG. 11. Conventional processes for producing hybrid composite parts thus include several stages and require multiple forming structures.

These and other shortcomings are addressed by aspects of the present disclosure.

### SUMMARY OF THE DISCLOSURE

According to one aspect, a molding process is configured to produce a hybrid composite part and includes configuring a mold cavity to receive a prepreg material, configuring the mold cavity further to receive an injection of material, providing a mold core comprising at least one main core, the at least one main core being configured to move with respect to the mold core, moving the mold core with respect to the mold cavity with a first actuator mechanism, moving the mold core to take a first configuration wherein the at least one main core is in a first position with respect to the mold core to receive the prepreg material, forming with the mold core in the first configuration a preform from the prepreg material, moving the mold core to take a second configuration wherein the at least one main core is in a second position with respect to the mold core, over molding onto the preform with the injection of the material with the mold core in the second configuration such that the mold cavity has the preform therebetween and forms a cavity between the mold core and the mold cavity.

According to another aspect, a molding device is configured to produce a hybrid composite part and includes a mold cavity configured to receive a prepreg material, the mold cavity further configured to receive an injection of material, a mold core comprising at least one main core, the at least one main core being configured to move with respect to the mold core, a first actuator mechanism configured to move the mold core with respect to the mold cavity, the mold core being configured to take a first configuration wherein the at least one main core is in a first position with respect to the mold core to receive the prepreg material, wherein the mold core in the first configuration interacts with the mold cavity with the prepreg material therebetween to form a preform from the prepreg material, the mold core being configured to take a second configuration wherein the at least one main core is in a second position with respect to the mold core, wherein the mold core in the second configuration interacts with the mold cavity with the preform therebetween and further comprises a cavity between the mold core and the mold cavity to receive the injection of the material for over molding onto the preform.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a partial cross-sectional view of device for producing hybrid composite parts in a first configuration according to the principles of the disclosure.

FIG. 2 shows the device for producing hybrid composite parts of FIG. 1 in a second configuration according to the principles of the disclosure.

FIG. 3 shows the device for producing hybrid composite parts of FIG. 1 in a third configuration according to the principles of the disclosure.

FIG. 4 shows the device for producing hybrid composite parts of FIG. 1 in a fourth configuration according to the principles of the disclosure.

FIG. 5 shows the device for producing hybrid composite parts of FIG. 1 in a fifth configuration according to the principles of the disclosure.

FIG. 6 shows an exemplary hybrid composite part produced with the device FIG. 1.

FIG. 7 shows another aspect of a device for producing hybrid composite parts according to the principles of the disclosure.

FIG. 8 shows another aspect of a device for producing hybrid composite parts according to the principles of the disclosure.

FIG. 9 shows a process applicable to a device for producing hybrid composite parts according to the principles of the disclosure.

FIG. 10 shows a controller constructed according to the principles of the disclosure.

FIG. 11 shows a prior art process for producing hybrid composite parts.

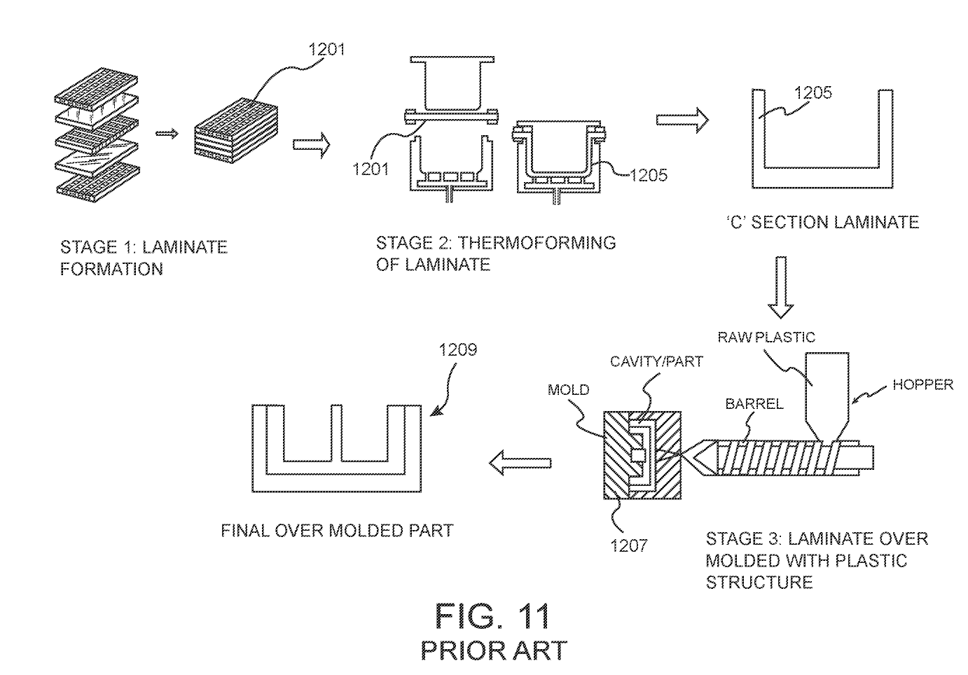

### DETAILED DESCRIPTION OF THE DISCLOSURE

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

The disclosure is directed to devices and methods of making hybrid composite parts. For example, continuous fiber reinforced laminates over molded with plastics. In the disclosure, a single step/stage process is described to make hybrid parts to replace existing multi-step/stage processes. Performance enhancement is achieved with improved part consolidation and reduced production times.

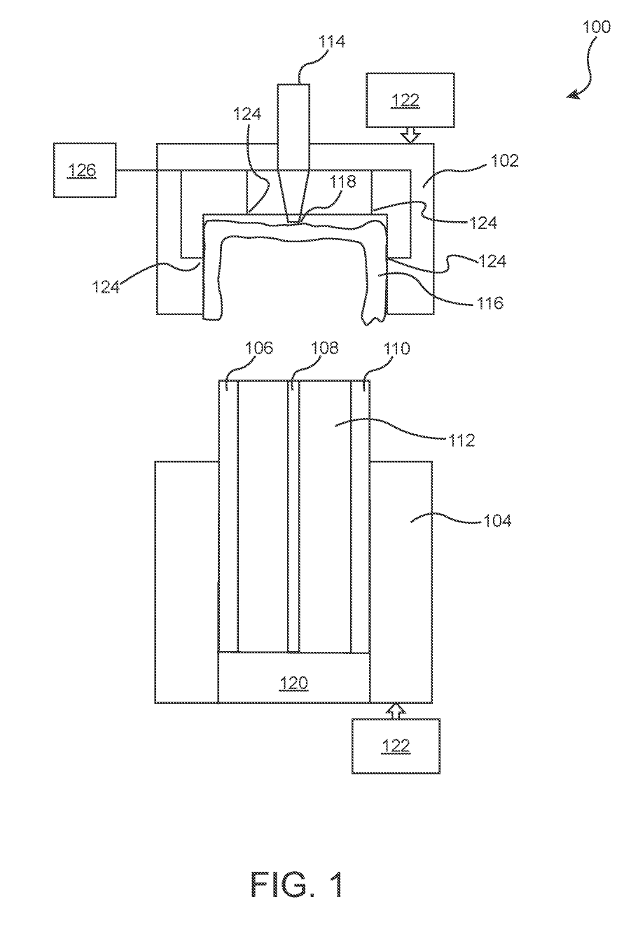

FIG. 1 shows a partial cross-sectional view of device for producing hybrid composite parts in a first configuration according to the principles of the disclosure. In particular, FIG. 1 shows a molding machine 100 that may include a mold cavity 102 and a corresponding mold core 104. In one aspect, the molding machine 100 and associated method is configured such that multiple stages are combined to utilize a single stage process to produce a hybrid composite part.

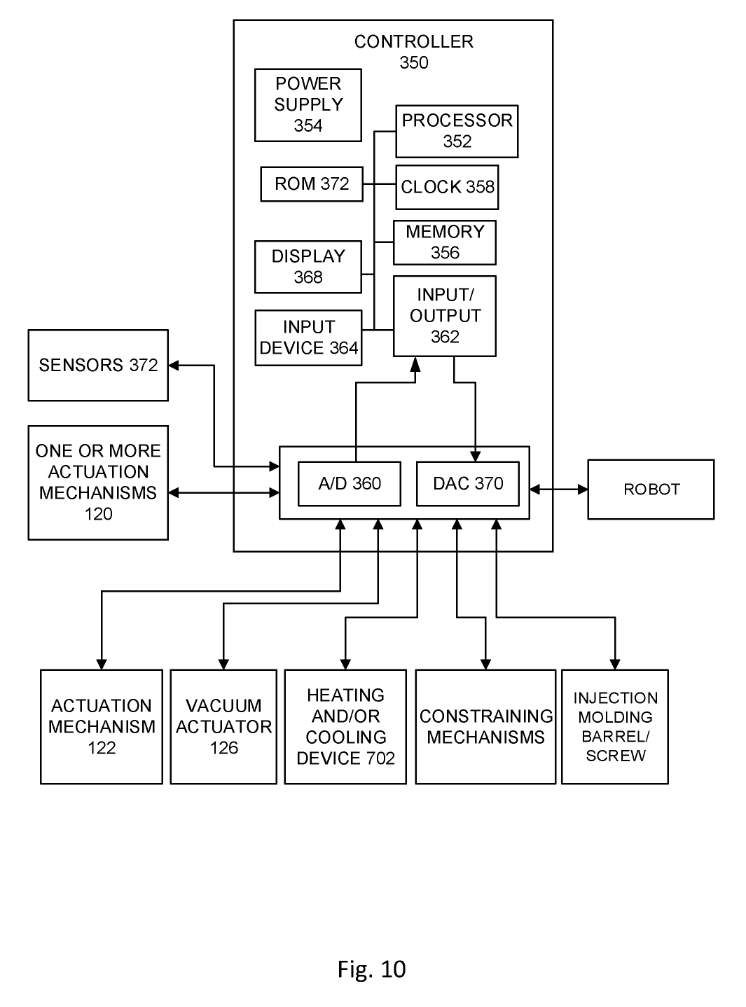

The molding machine 100 may further include an actuation mechanism 122 associated with the mold cavity 102 and/or the mold core 104. The actuation mechanism 122 may move the mold cavity 102 and/or the mold core 104 such that the mold cavity 102 engages the mold core 104. The actuation mechanism 122 may be implemented as a hydraulic actuator, a pneumatic actuator, an electromagnetic actuator, or the like. The actuation mechanism 122 may be controlled by a controller illustrated in FIG. 10.

The mold core 104 may include one or more mold core inserts 106, 108, 110. As shown in FIG. 1, the mold core inserts 106, 108, 110 may be arranged in and around a main core 112. The positioning of the mold core inserts 106, 108, 110 is exemplary. The mold core inserts 106, 108, 110 may be located anywhere in conjunction with the main core 112. In one aspect, the mold core inserts 106, 108, 110 may be located along the periphery of the main core 112. In another aspect, the mold core inserts 106, 108, 110 may be located within the main core 112. In the aspect shown in FIG. 1, the mold core inserts 106, 108, 110 may be located along the periphery (106, 110) of the main core 112 and may be located internally (108) to the main core 112. Moreover, although three mold core inserts 106, 108, 110 are illustrated in FIG. 1, any number of mold core inserts may be utilized. Additionally, although a single main core 112 is illustrated in FIG. 1, any number of main cores may be utilized.

The mold core inserts 106, 108, 110 and the main core 112 are configured to move with respect to the mold core 104 by operation of one or more actuation mechanisms 120. In one aspect, there may be a single actuation mechanism 120 for moving the mold core inserts 106, 108, 110 and the main core 112. In another aspect, there may be an actuation mechanism 120 for moving the mold core inserts 106, 108, 110 and another actuation mechanism 120 for moving the main core 112. In another aspect, there may be an actuation mechanism 120 for moving each of the mold core inserts 106, 108, 110 and another actuation mechanism 120 for moving the main core 112. The one or more actuation mechanisms 120 may be implemented as a hydraulic actuator, a pneumatic actuator, an electromagnetic actuator, or the like. The one or more actuation mechanisms 120 may be controlled by the controller illustrated in FIG. 10.

In one aspect, the mold core inserts 106, 108, 110 and the main core 112 may have a textured surface that engages a prepreg 116. In one aspect, the prepreg 116 may include a stack of laminate plies. In one aspect, the mold core inserts 106, 108, 110 may have a textured surface that engages the prepreg 116. In one aspect, the main core 112 may have a textured surface that engages the prepreg 116. The textured surface that engages the prepreg 116 subsequently forms a textured surface on the prepreg 116 during production of the subsequent preform 202. The textured surface on the prepreg 116 may improve adhesion to a subsequent molded plastic structure and/or other benefits. The textured surface may include a roughened surface, diamond, ridge, groove, and the like features.

The mold cavity 102 may be configured to receive the prepreg 116. In one aspect, the prepreg 116 may be made from a first fiber-reinforced polymer material having a two-dimensional, three-dimensional, woven, co-mingled and/or similar structure. In one aspect, the prepreg 116 may be made from a first fiber-reinforced polymer material as defined below. In one aspect, the prepreg 116 may also include a first thermoplastic resin as defined below. In one aspect, the prepreg 116 may include a thermoset material. In one aspect, the prepreg 116 may include ply layups.

The molding machine 100 may further include an injector pin 114 configured to inject a second thermoplastic resin and/or a second reinforced polymer material into the mold cavity 102. In one aspect, the second thermoplastic resin may be any type of thermoplastic resin. In one aspect, the second thermoplastic resin may be a thermoplastic resin as defined below. In one aspect, the injector pin 114 may receive the second thermoplastic resin from an injection molding barrel/screw. In one aspect, the second reinforced polymer material may be any type of reinforced polymer material. In one aspect, the second reinforced polymer material may be reinforced polymer material as defined below. In one aspect, the injector pin 114 may receive the second reinforced polymer material from an injection molding barrel/screw.

As further shown in FIG. 1, the prepreg 116 may be arranged in the mold cavity 102. In one aspect, the prepreg 116 may be arranged in the mold cavity 102 with the help of a robot that may be controlled by the controller illustrated in FIG. 10. In one aspect, the prepreg 116 may be arranged in the mold cavity 102 with the help of a machine that may be controlled by the controller illustrated in FIG. 10. In one aspect, the prepreg 116 may be arranged in the mold cavity 102 by other processes.

In one aspect, the prepreg 116 may be located in the molding machine 100 and clamped utilizing mechanical methods, vacuum clamps, and the like. In one aspect, mechanical methods may be utilized. In this aspect, the prepreg 116 is placed in the molding machine 100 parting surface by the robot and the mold core inserts 106, 108, 110 from the mold core 104 and the mold cavity 102 can be used for clamping. The mold core inserts 106, 108, 110 clamping the prepreg 116 may move synchronously with the rest of the mold core 104 and the mold cavity 102 movement for forming, lamination and over molding. Further, the clamping surface of the mold core inserts 106, 108, 110 can be textured as noted above to increase the friction with fabric for efficient locating.

In another aspect, vacuum clamps may be utilized. In this aspect, one or more vacuum vents 124 can be located in the mold cavity 102 or any part of the molding machine 100. For example the mold cavity 102 can have vacuum vents 124 which hold the prepreg 116 in its place during the forming process. Additionally, the vacuum vents 124 may include conduits that connect to a vacuum actuator 126 that may include a vacuum source.

In one aspect, the prepreg 116 may include features to ensure a proper location in the mold cavity 102. In this regard, the mold cavity 102 may have corresponding structure to engage the features arranged in the prepreg 116. In one aspect, the prepreg 116 may include locator holes to ensure the proper location in the mold cavity 102. In this regard, the mold cavity 102 may have corresponding structure to engage the locator holes arranged in the prepreg 116.

In one aspect, the injector pin 114 may be configured with features to engage the prepreg 116. In one aspect, the injector pin 114 may include a gripping feature that engages the prepreg 116 to grip and hold the prepreg 116. In one aspect, the injector pin 114 may include a feature 118 that engages a locator hole in the prepreg 116 to hold the prepreg 116.

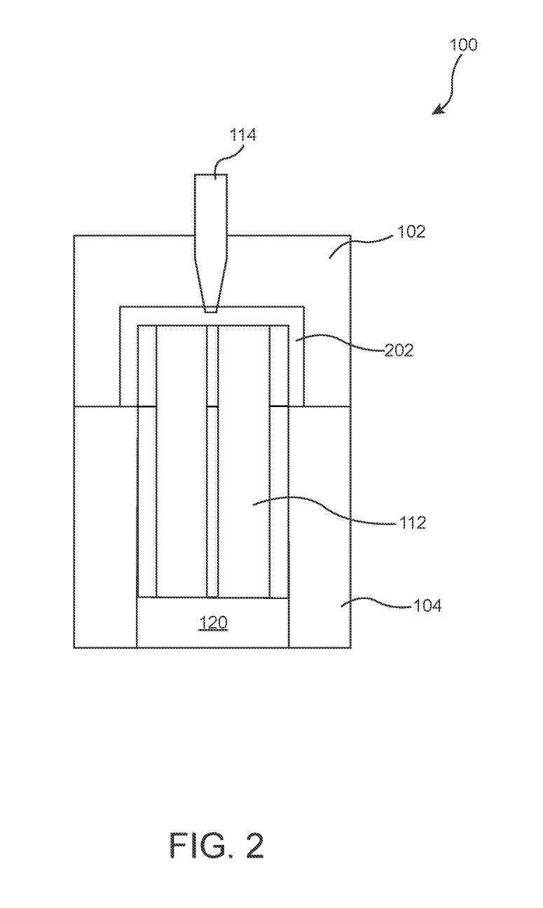

Further in the first configuration shown in FIG. 1, the mold core inserts 106, 108, 110, and the main core 112 may be fully extended by the one or more actuation mechanisms 120 in preparation for closure of the mold. Thereafter, the mold cavity 102 and mold core 104 may be moved to close the molding machine 100 to the configuration shown in FIG. 2 with the actuation mechanism 122. Alternatively, the mold cavity 102 and mold core 104 may be moved to close the molding machine 100 to the configuration shown in FIG. 2 with actuation mechanism 122. Thereafter the mold core inserts 106, 108, 110, and the main core 112 may be fully extended by the one or more actuation mechanisms 120.

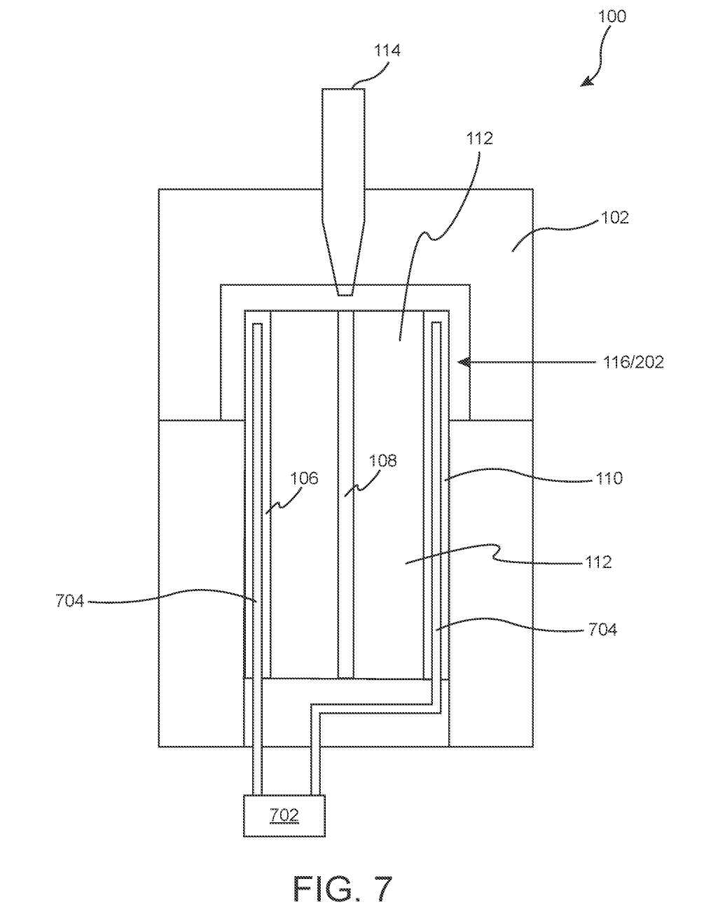

FIG. 2 shows the device for producing hybrid composite parts of FIG. 1 in a second configuration according to the principles of the disclosure. In particular, FIG. 2 shows the mold cavity 102 arranged to engage with the mold core 104 with the prepreg 116 arranged therebetween. The prepreg 116 may be heated in the molding machine 100 utilizing a heating device described below in conjunction with FIG. 7. The mold core inserts 106, 108, 110, and the main core 112 may be fully extended by the one or more actuation mechanisms 120 and the molding machine 100 may apply a uniform pressure to the prepreg 116 with the actuation mechanism 122 even after closing the mold and the prepreg 116 forms a shape of the mold cavity 102. Thereafter, the molding machine 100 may allow the prepreg 116 to cool in the mold itself to retain the shape of the mold cavity 102. The cooled prepreg 116 may thereafter be formed into a preform 202.

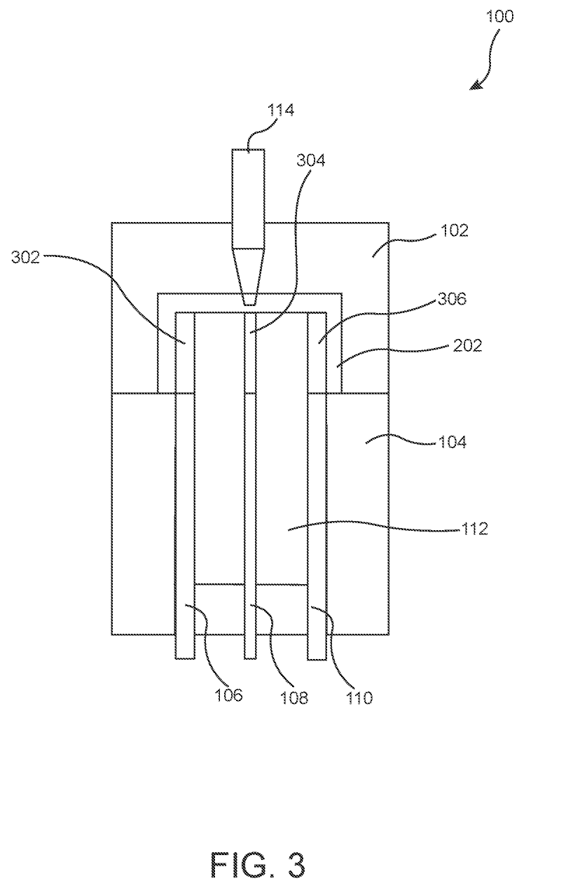

FIG. 3 shows the device for producing hybrid composite parts of FIG. 1 in a third configuration according to the principles of the disclosure. In particular, FIG. 3 shows that the mold core inserts 106, 108, 110 may be retracted by the one or more actuation mechanisms 120. The amount of retraction by the mold core inserts 106, 108, 110 may be indicative of the length and/or size of the plastic structure to be over molded onto the preform 202.

In one aspect, after the mold core inserts 106, 108, 110 are retracted, the injector pin 114 may inject the second thermoplastic resin and/or the second reinforced polymer material into the mold cavity 102 in the area 302, 304, 306 where the mold core inserts 106, 108, 110 were previously located. In another aspect, the injection will be delayed until the main core 112 is retracted as described below.

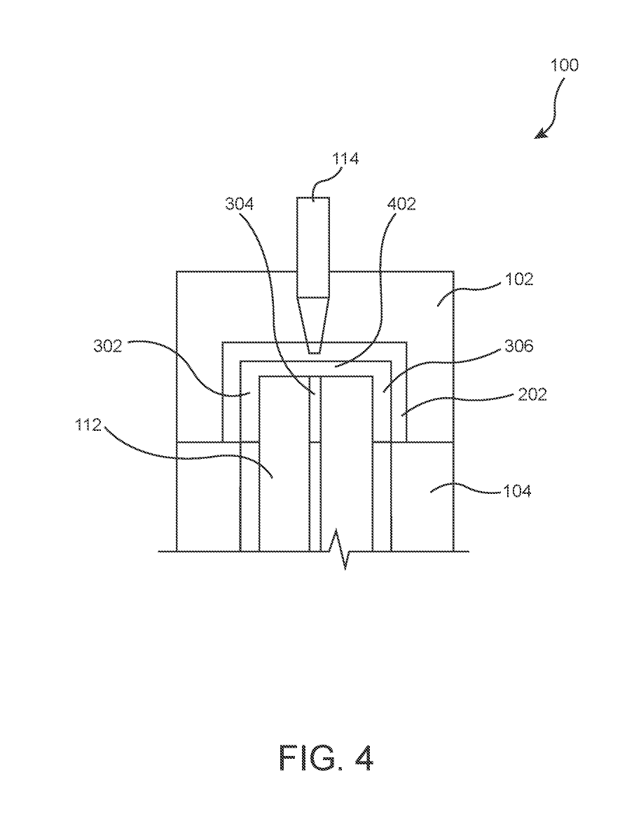

FIG. 4 shows the device for producing hybrid composite parts of FIG. 1 in a fourth configuration according to the principles of the disclosure. In particular, FIG. 4 shows that the main core 112 may be retracted by the one or more actuation mechanisms 120 to create an area 402. The amount of retraction by the mold core inserts 106, 108, 110 and main core 112 may be indicative of the size, length, position, and the like of the plastic structure to be over molded onto the preform 202.

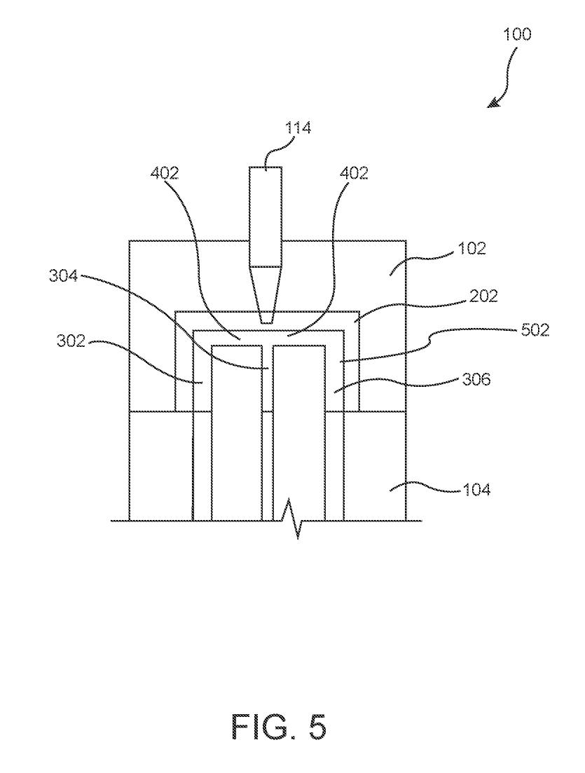

FIG. 5 shows the device for producing hybrid composite parts of FIG. 1 in a fifth configuration according to the principles of the disclosure. In particular, FIG. 5 shows that after the mold core inserts 106, 108, 110 and the main core 112 are retracted, the injector pin 114 may inject the second thermoplastic resin, and/or the second reinforced polymer material into the mold cavity 102 in the area 302, 304, 306 where the mold core inserts 106, 108, 110 were previously located and the area 402 where the main core 112 was previously located to form a plastic over molding structure 502.

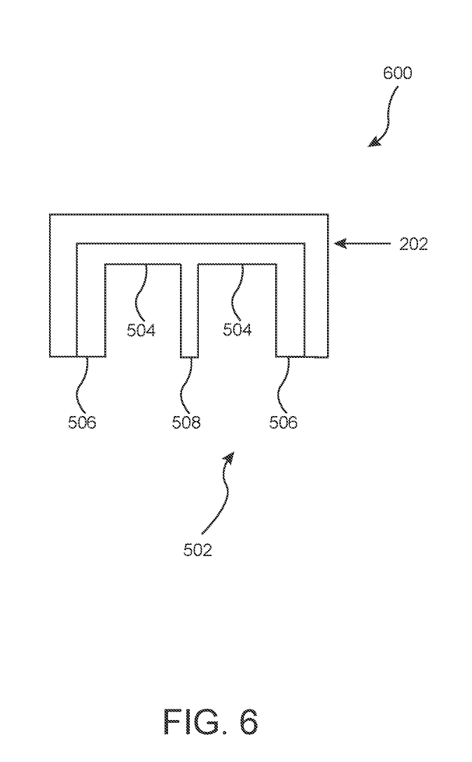

In other words, after creating the preform 202, the mold core inserts 106, 108, 110 are moved to create a cavity in area 302, 304, 306 of the mold cavity 102 a length of the plastic structure to form side walls and/or a rib for a subsequent plastic part as shown in FIG. 4. After that, as shown FIG. 5 the main core 112 may move back at thickness of the plastic structure to create a cavity (area 402) at top side of the part. After all the core movement required is accomplished, a cavity is created in the tool to inject a shot in the same tool as shown in FIGS. 1-5. The plastic may be injected to create the over mold structure part and final shape of the exemplary part is shown in FIG. 6.

FIG. 6 shows an exemplary hybrid composite part produced with the device FIG. 1. In particular, FIG. 6 shows the final part 600 that includes the preform 202 and the plastic over molding structure 502. As illustrated in FIG. 6, the final part 600 includes portions of the preform 202 extending along the periphery of the final part 600. Moreover, the final part 600 includes the plastic over molding structure 502 with portions 504 along an inside bottom surface of the final part 600. Additionally, the final part 600 includes the plastic over molding structure 502 with portions 506 along an inside side surface of the final part 600. Additionally, the final part 600 includes the plastic over molding structure 502 with portions 508 forming a rib in the final part 600. It should be noted that the hybrid composite final part 600 shown in FIG. 6 is merely exemplary. Other structural configurations and arrangements are contemplated to be produced by the molding machine 100 of the disclosure.

FIG. 7 shows another aspect of a device for producing hybrid composite parts according to the principles of the disclosure. In particular, FIG. 7 shows an aspect where selective heating and cooling can be incorporated in the mold cavity 102 and/or the mold core 104 to heat the prepreg 116 only at particular areas during the heating phase. Once the prepreg 116 is preformed in the cavity shape after the forming, cooling can be accomplished in the same manner and this may control a fiber movement of the prepreg 116. Heating and softening the entire prepreg 116 during forming may allow fibers, even in a no forming zone, to move in an undesirable manner. On the other hand, selective heating only in a forming zone may help in controlled movement of fibers of the prepreg 116.

In particular, this method may help in controlled movement of fibers of the prepreg 116 by allowing the fibers to move only where required. Moreover, this process may be used when the prepreg 116 is loaded into the molding machine 100 for heating and forming. When the prepreg 116 is loaded in the molding machine 100 and clamped, the molding machine 100 closes. After the molding machine 100 is closed, heated fluid (oil, pressurized water, or the like) may be passed in the channels 704 of the mold core inserts 106, 108, 110 which concentrate the heat only in the regions where the prepreg 116 has to form. This is achieved by carefully designing the channels 704 in the mold core inserts 106, 108, 110 where the prepreg 116 is formed. After the forming is completed, the fluid temperature in the channels can be reduced to maintain the temperature at a normal preheat temperature as used in over molding. In one aspect, these channels 704 will be different from the cooling channels in the mold which are usually used to maintain the mold temperature. Other locations for the channels 704 are contemplated as well.

In this regard, FIG. 7 shows a device 702 providing a source of heating and cooling to the molding machine 100. The device 702 may be a source of heated fluid such as hot air, hot water, steam, hot oil, and the like. The device 702 may also be a source of cold fluid such as cold air, cold water, and the like. The device 702 may provide the source of heated fluid selectively to the channels 704 that are arranged in one or more of the mold core inserts 106, 108, 110. Alternatively, the device 702 could provide fluid selectively to the channels 704 arranged in the mold cavity 102 and/or the mold core 104. Likewise, the device 702 may provide the source of cold fluid selectively to the channels 704. The device 702 may be controlled by the controller illustrated in FIG. 10 to selectively provide a particular temperature of fluid to the channels 704. Accordingly, the desired temperature may be controlled for each portion of the molding machine 100. It should be appreciated that any number of channels 704 may be utilized in the molding machine 100 and any number of devices 702 may be utilized as needed by the particular application.

In another aspect, the device 702 may be a source of electricity. In this regard, the channel 704 may alternatively be implemented as resistive or inductive heating devices. Moreover, it should be appreciated that other types of cooling and heating technologies may be utilized as well consistent with the concept of being able to selectively control the amount and location of heating and/or cooling in the molding machine 100.

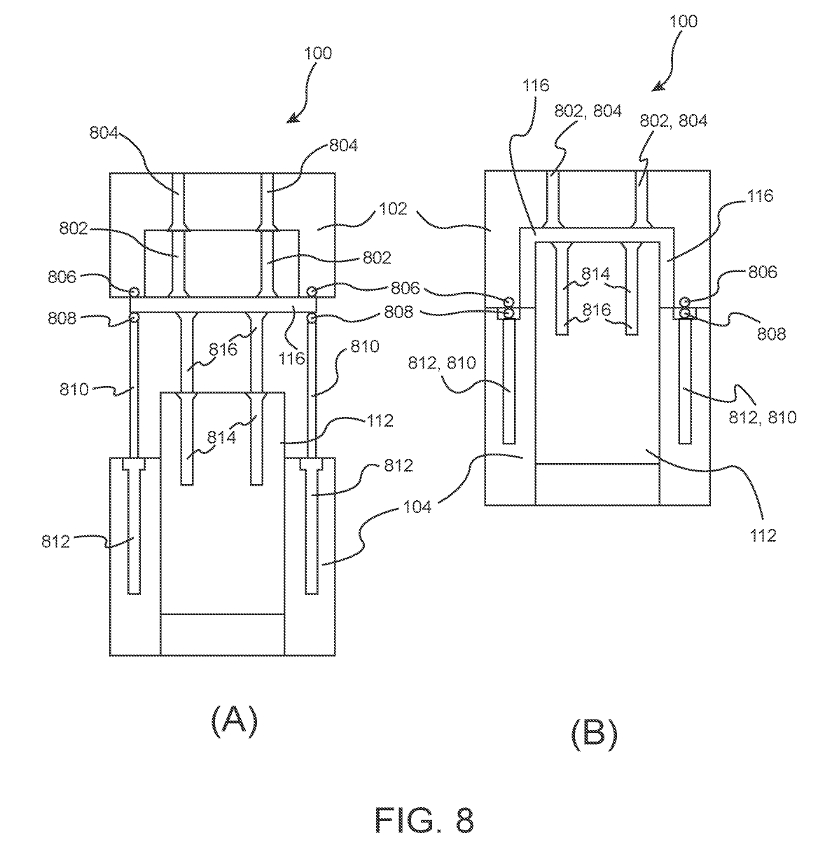

FIG. 8 shows another aspect of a device for producing hybrid composite parts according to the principles of the disclosure. The aspects of FIG. 8 may or may not be utilized with any other aspect of the disclosure. In particular, unconstrained forming of the preform 202 from the prepreg 116 may result in fiber movement that is random and may result in wrinkles in the preform 202. Accordingly, FIG. 8 shows an aspect that includes constraining mechanisms that hold the prepreg 116 during the forming process of the preform 202. The constraining mechanisms may be arranged at various locations on the mold cavity 102, the mold core 104, or elsewhere in the molding machine 100 in order to hold and constrain the prepreg 116 during the phase that includes creating the preform 202.

As further shown in FIG. 8, the mold cavity 102 may include at least one support 802 that may extend into the cavity portion of the mold cavity 102. The support 802 may have a corresponding housing 804 to house the support 802. The housing 804 may further include an actuation mechanism to extend the support 802 to the position shown in FIG. 8A and/or retract the support 802 to the position shown in FIG. 8B. The actuation mechanism may be implemented as a spring, a hydraulic actuator, a pneumatic actuator, an electromagnetic actuator, or the like.

As further shown in FIG. 8, the main core 112 may include at least one support 816 that may extend from the main core 112. The support 816 may have a corresponding housing 814 to house the support 816. The housing 814 may further include an actuation mechanism to extend the support 816 to the position shown in FIG. 8A and/or retract the support 816 to the position shown in FIG. 8B. The actuation mechanism may be implemented as a spring, a hydraulic actuator, a pneumatic actuator, an electromagnetic actuator, or the like.

As further shown in FIG. 8, the mold core 104 may include at least one support 810 that may extend from the main core 112. The support 810 may have a corresponding housing 812 to house the support 810. The housing 812 may further include an actuation mechanism to extend the support 810 to the position shown in FIG. 8A and/or retract the support 810 to the position shown in FIG. 8B. The actuation mechanism may be implemented as a spring, a hydraulic actuator, a pneumatic actuator, an electromagnetic actuator, or the like.

The support 810 may further include at least one roller 808 positioned on a terminal end of the support 810. The roller 808 may include a roller shaft and be constructed to freely rotate about the roller shaft. In another aspect, the roller 808 may be implemented as a freely rotatable ball structure.

The mold cavity 102 may further include a roller 806 positioned on a lower surface thereof. The roller 806 may include a roller shaft and be constructed to freely rotate about the roller shaft. In another aspect, the roller 806 may be implemented as a freely rotatable ball structure.

One or more of the supports 802, 810, 816 may support the prepreg 116 and may hold the prepreg 116 firmly and move relative to the mold opening to facilitate forming. The rollers 806, 808 may allow the prepreg 116 to slide into the mold for forming. In one aspect, the one or more supports 802, 810, 816 may configured to extend in unison to support the prepreg 116 in response to operation of the actuation mechanism. In one aspect, the one or more supports 802, 810, 816 may configured to selectively extend to support the prepreg 116 in response to operation of the actuation mechanism. In one aspect, the one or more supports 802, 810, 816 may configured to retract in response to operation of the actuation mechanism when the mold closes. In one aspect, the one or more supports 802, 810, 816 may be configured as one or more of the mold core inserts 106, 108, 110.

In other aspects, the constraining mechanisms may be implemented by a stripper plate that contacts one surface of the prepreg 116 and a corresponding pressure surface that contacts the opposing side of the prepreg 116. In this regard, the stripper plate and pressure surface combination may securely hold the prepreg 116 while the mold core 104 is received into the mold cavity 102.

Accordingly, the prepreg 116 is less likely to be subjected to fiber movement, wrinkling and the like. The constraining mechanisms may alternatively be implemented in numerous other ways to hold the prepreg 116 in a taut manner. In one aspect, the constraining mechanisms may be controlled by the controller illustrated in FIG. 10. Accordingly, constraining the prepreg 116 before forming and allowing fiber movement only in the forming regions may reduce wrinkles. The constraining mechanism may be implemented as a hydraulic actuator, a pneumatic actuator, an electromagnetic actuator, or the like. The constraining mechanism may be controlled by the controller illustrated in FIG. 10. The method may also help in controlling the forming process to reduce the risk of wrinkles. The concept used here is to keep the prepreg 116 under tension during forming which will not allow fibers to move freely during forming.

If a hydraulic actuator is utilized, the hydraulic actuator may include a hydraulic cylinder and a source of pressurized hydraulic fluid configured as a hydraulic system. If a pneumatic actuator is utilized, the pneumatic actuator may include a pneumatic cylinder and a source of pressurized pneumatic fluid configured as a pneumatic system. If an electromagnetic actuator is utilized, the electromagnetic actuator may include a solenoid and a source of electrical power to operate the solenoid configured as an electromagnetic system. Other implementations are contemplated as well.

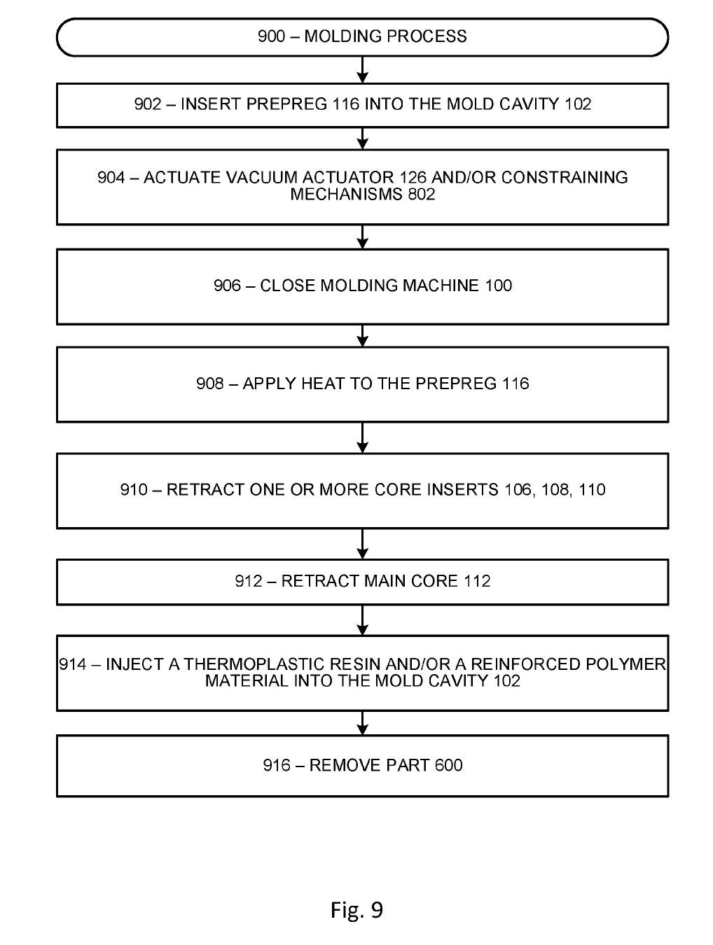

FIG. 9 shows a process applicable to a device for producing hybrid composite parts according to the principles of the disclosure. In particular, FIG. 9 shows a molding process 900. In process box 902, the prepreg 116 may be inserted into the mold cavity 102. This may be accomplished by a robot actuated by the controller 350, by a machine actuated by the controller 350, or by other processes.

In process box 904, the vacuum actuator 126 and/or the constraining mechanisms may be actuated to hold the prepreg 116 within the molding machine 100. In process box 906, the molding machine 100 may be closed by operation of the actuation mechanism 122. In process box 908, heat may be applied to the prepreg 116 from the heating and/or cooling device 702.

In process box 910, the one or more mold core inserts 106, 108, 110 may be retracted by the one or more actuation mechanisms 120. In process box 912, the main core 112 may be retracted by the one or more actuation mechanisms 120. The processes 910 and 912 may occur simultaneously or in any order.

In process box 914, a thermoplastic resin and/or a reinforced polymer material is injected into the mold cavity 102 by the injector pin 114. In process box 916, the final part 600 is complete and the final part 600 may be removed for further processing as needed.

In tests, the hybrid composite final part 600 was produced with minimum effort and time to meet different market production requirements. Fiber bundles of the hybrid composite final part 600 were un-disturbed and kept in form with the disclosed process. The temperature gradient development at local regions helped in guiding the melt resin through the ply-layups.

FIG. 10 shows a controller constructed according to the principles of the disclosure. The controller 350 may receive sensor outputs from one or more sensors 372, such as a temperature sensor sensing temperature from any part of the molding machine 100 and associated system, a pressure sensor sensing pressure from a part of the molding machine 100 and associated system, a position sensor sensing position of a part of the molding machine 100 and associated system, and the like.

The controller 350 may include a processor 352. This processor 352 may be operably connected to a power supply 354, a memory 356, a clock 358, an analog to digital converter (A/D) 360, an input/output (I/O) port 362, and the like. The I/O port 362 may be configured to receive signals from any suitably attached electronic device and forward these signals from the A/D 360 and/or to processor 352. These signals include signals from the sensors 372. If the signals are in analog format, the signals may proceed via the A/D 360. In this regard, the A/D 360 may be configured to receive analog format signals and convert these signals into corresponding digital format signals.

The controller 350 may include a digital to analog converter (DAC) 370 that may be configured to receive digital format signals from the processor, convert these signals to analog format, and forward the analog signals from the I/O port 362. In this manner, electronic devices configured to utilize analog signals may receive communications or be driven by the processor 352. The processor 352 may be configured to receive and transmit signals to and from the DAC 370, A/D 360 and/or the I/O port 362. The processor 352 may be further configured to receive time signals from the clock 358. In addition, the processor 352 may be configured to store and retrieve electronic data to and from the memory 356. The controller 350 may further include a display 368, an input device 364, and a read-only memory (ROM) 372. Finally, the processor 352 may include a program stored in the memory 356 executed by the processor 352 to execute the process 900 described herein.

The controller 350 and I/O port 362 may be configured to control operation of the molding machine 100 and receive signals from the molding machine 100. These signals include signals from the sensors 372 and the like. The controller 350 may control operation the molding machine 100 including the one or more actuation mechanisms 120, the actuation mechanism 122, the vacuum actuator 126, the heating and/or cooling device 702, the constraining mechanisms, the injection molding barrel/screw, the robot, and the like.

Aspects of the disclosure may utilize an injection molding barrel/screw (not shown). An injection molding barrel/screw may include a hopper. Pellets of thermoplastic material and/or fiber reinforced thermoplastics may be supplied by the hopper to the injection molding barrel/screw. In some aspects, a gas (blowing agent) from a gas source may be introduced. The injection molding barrel/screw may include a cylinder maintaining a screw. The screw may further include a motor or the like for moving the screw. Additionally, the injection molding barrel/screw may include at least one heater. A nozzle and/or an associated shutoff valve may include at least one heater to maintain a temperature of the pellets and/or increase the temperature of the pellets to melt the same. Other constructions associated with the injection molding barrel/screw are contemplated as well.

The first fiber-reinforced polymer material may include a laminate made from at least one of a uni-directional tape, a prepack roll, a two-dimensional fabric, a three-dimensional fabric, commingled fibers, a film, a woven fabric, and a non-woven fabric. The first fiber-reinforced polymer material may be made through a melt process, from a chemical solution, from a powder, by film impregnation, or the like. The woven and non-woven fabric materials may be made from the first thermoplastic resin.

Specific non-limiting examples of suitable first thermoplastic resins include polyacetal, polyacrylic, styrene acrylonitrile, acrylonitrile-butadiene-styrene (ABS), polycarbonate, polystyrene, polyethylene, polyphenylene ether, polypropylene, polyethylene terephthalate, polybutylene terephthalate, Nylons (Nylon-6, Nylon-6/6, Nylon-6/10, Nylon-6/12, Nylon-11 or Nylon-12, for example), polyamideimide, polyarylate, polyurethane, ethylene propylene diene rubber (EPR), ethylene propylene diene monomer (EPDM), polyarylsulfone, polyethersulfone, polyphenylene sulfide, polyvinyl chloride, polysulfone, polyetherimide, polytetrafluoroethylene, fluorinated ethylene propylene, perfluoroalkoxyethylene, polychlorotrifluoroethylene, polyvinylidene fluoride, polyvinyl fluoride, polyetherketone, polyether ether ketone (PEEK), liquid crystal polymers and mixtures comprising any one of the foregoing thermoplastics. The thermoplastic resin may also be propriety resin materials, such as Noryl GTX™, which is a blend of polyamide and modified polyphenylene ether, or Thermocomp RC008™, which is a Nylon 66 resin. It is anticipated that any thermoplastic resin may be used in the present disclosure that is capable of being sufficiently softened by heat to permit fusing and/or molding without being chemically or thermally decomposed.

The second fiber-reinforced polymer material may be selected from the non-exhaustive list of the first fiber-reinforced polymer material described herein. The second thermoplastic resin may be selected from the non-exhaustive list of first thermoplastic resins described above. Although the second thermoplastic resin may be different than the first thermoplastic resin, it may be desirable that the first thermoplastic resin and the second thermoplastic resin share a common polymeric material. The specific materials mentioned above are merely described for exemplary purposes.

The first fiber-reinforced polymer material may also include at least one type of continuous fiber material designed to help provide strength to the prepreg 116. Fibers suitable for use in the disclosure include glass fibers, carbon fibers, graphite fibers, synthetic organic fibers, particularly high modulus organic fibers such as para- and meta-aramid fibers, nylon fibers, polyester fibers, or any of the thermoplastic resins mentioned above that are suitable for use as fibers, natural fibers such as hemp, sisal, jute, flax, coir, kenaf and cellulosic fibers, mineral fibers such as basalt, mineral wool (e.g., rock or slag wool), Wollastonite, alumina silica, and the like, or mixtures thereof, metal fibers, metalized natural and/or synthetic fibers, ceramic fibers, or mixtures thereof. In one aspect, the fibers selected for the first fiber-reinforced polymer material of the prepreg 116 are continuous carbon-fibers.

Articles produced according to the disclosure include, for example, computer and business machine housings, home appliances, trays, plates, handles, helmets, automotive parts such as instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present disclosure include exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated articles; and like applications.

In one aspect, the parts can include articles including the disclosed glass fiber filled polymeric materials. In a further aspect, the article including the disclosed glass fiber filled polymeric materials can be used in automotive applications. In a yet further aspect, the article includes the disclosed glass fiber filled polymeric materials can be selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article including the disclosed glass fiber filled polymeric materials can be selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the parts can include electrical or electronic devices including the disclosed glass fiber filled polymeric materials. In a further aspect, the electrical or electronic device can be a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

### EXAMPLES

### Example 1

A process configured to produce a hybrid composite part, comprising: configuring a mold cavity to receive a prepreg material; configuring the mold cavity further to receive an injection of material; providing a mold core comprising at least one main core, the at least one main core being configured to move with respect to the mold core; moving the mold core with respect to the mold cavity with a first actuator mechanism; moving the mold core to take a first configuration wherein the at least one main core is in a first position with respect to the mold core to receive the prepreg material; forming with the mold core in the first configuration a preform from the prepreg material; moving the mold core to take a second configuration wherein the at least one main core is in a second position with respect to the mold core; over molding onto the preform with the injection of the material with the mold core in the second configuration such that the mold cavity has the preform therebetween and forms a cavity between the mold core and the mold cavity.

### Example 2

A process configured to produce a hybrid composite part, consisting of: configuring a mold cavity to receive a prepreg material; configuring the mold cavity further to receive an injection of material; providing a mold core comprising at least one main core, the at least one main core being configured to move with respect to the mold core; moving the mold core with respect to the mold cavity with a first actuator mechanism; moving the mold core to take a first configuration wherein the at least one main core is in a first position with respect to the mold core to receive the prepreg material; forming with the mold core in the first configuration a preform from the prepreg material; moving the mold core to take a second configuration wherein the at least one main core is in a second position with respect to the mold core; over molding onto the preform with the injection of the material with the mold core in the second configuration such that the mold cavity has the preform therebetween and forms a cavity between the mold core and the mold cavity.

### Example 3

A process configured to produce a hybrid composite part, consisting essentially of: configuring a mold cavity to receive a prepreg material; configuring the mold cavity further to receive an injection of material; providing a mold core comprising at least one main core, the at least one main core being configured to move with respect to the mold core; moving the mold core with respect to the mold cavity with a first actuator mechanism; moving the mold core to take a first configuration wherein the at least one main core is in a first position with respect to the mold core to receive the prepreg material; forming with the mold core in the first configuration a preform from the prepreg material; moving the mold core to take a second configuration wherein the at least one main core is in a second position with respect to the mold core; over molding onto the preform with the injection of the material with the mold core in the second configuration such that the mold cavity has the preform therebetween and forms a cavity between the mold core and the mold cavity.

### Example 4

The process according to any one of examples 1 to 3, wherein the mold core comprising the at least one main core further comprises at least one mold core insert; and wherein the at least one mold core insert being configured to move with respect to the mold core.

### Example 5

The process according to any one of examples 1 to 5, wherein the first configuration further comprises the at least one mold core insert being in a first position with respect to the mold core to receive the prepreg material; and wherein the second configuration further comprises the at least one mold core insert being in a second position with respect to the mold core.

### Example 6

The process according to any one of examples 1 to 5, further comprising moving with at least one second actuator mechanism at least one of the following: the at least one mold core insert with respect to the mold core and the at least one main core with respect to the mold core.

### Example 7

The process according to any one of examples 1 to 6, further comprising holding the prepreg material with respect to the mold cavity with at least one constraining mechanism.

### Example 8

The process according to any one of examples 1 to 7, wherein the at least one mold core insert is arranged along a periphery of the at least one main core.

### Example 9

The process according to any one of examples 1 to 8, wherein the at least one mold core insert is arranged in the at least one main core.

### Example 10

The process according to any one of examples 1 to 9, wherein the at least one mold core insert is arranged along a periphery of the at least one main core; and wherein another at least one mold core insert is arranged in the at least one main core.

### Example 11

The process according to any one of examples 1 to 10, wherein the at least one mold core insert comprises a textured surface.

### Example 12

The process according to any one of examples 1 to 11, wherein the at least one main core comprises a textured surface.

### Example 13

The process according to any one of examples 1 to 12, further comprising heating with a heating device configured to heat at least one of the following: the mold core, the at least one mold core insert, the at least one main core, and the mold cavity.

### Example 14

The process according to any one of examples 1 to 13, wherein the heating device is configured to selectively heat the at least one mold core insert.

### Example 15

The process according to any one of examples 1 to 114, further comprising at least one injector pin configured to inject the material arranged on at least one of the following: the mold core and the mold cavity.

### Example 16

The process according to any one of examples 1 to 15, further comprising holding the prepreg material with the at least one injector pin that further comprises a piercing structure.

### Example 17

The process according to any one of examples 1 to 16, wherein the at least one constraining mechanism comprises at least one of the following: a vacuum actuator, a support, and a roller.

### Example 18

The process according to any one of examples 1 to 17, wherein the at least one constraining mechanism comprises a vacuum actuator arranged in the at least one mold core insert.

### Example 19

The process according to any one of examples 1 to 18, wherein the mold cavity comprises structure to engage locator holes arranged in the prepreg material.

### Example 20

The process according to any one of examples 1 to 19, further comprising a controller configured to control at least one of the following: the at least one constraining mechanism, the heating device, the first actuator mechanism, and the at least one second actuator mechanism.

### Example 21

A device configured to produce a hybrid composite part, comprising: a mold cavity configured to receive a prepreg material; the mold cavity further configured to receive an injection of material; a mold core comprising at least one main core, the at least one main core being configured to move with respect to the mold core; a first actuator mechanism configured to move the mold core with respect to the mold cavity; the mold core being configured to take a first configuration wherein the at least one main core is in a first position with respect to the mold core to receive the prepreg material; wherein the mold core in the first configuration interacts with the mold cavity with the prepreg material therebetween to form a preform from the prepreg material; the mold core being configured to take a second configuration wherein the at least one main core is in a second position with respect to the mold core; wherein the mold core in the second configuration interacts with the mold cavity with the preform therebetween and further comprises a cavity between the mold core and the mold cavity to receive the injection of the material for over molding onto the preform.

### Example 22

A device configured to produce a hybrid composite part, consisting of: a mold cavity configured to receive a prepreg material; the mold cavity further configured to receive an injection of material; a mold core comprising at least one main core, the at least one main core being configured to move with respect to the mold core; a first actuator mechanism configured to move the mold core with respect to the mold cavity; the mold core being configured to take a first configuration wherein the at least one main core is in a first position with respect to the mold core to receive the prepreg material; wherein the mold core in the first configuration interacts with the mold cavity with the prepreg material therebetween to form a preform from the prepreg material; the mold core being configured to take a second configuration wherein the at least one main core is in a second position with respect to the mold core; wherein the mold core in the second configuration interacts with the mold cavity with the preform therebetween and further comprises a cavity between the mold core and the mold cavity to receive the injection of the material for over molding onto the preform.

### Example 23

A device configured to produce a hybrid composite part, consisting essentially of: a mold cavity configured to receive a prepreg material; the mold cavity further configured to receive an injection of material; a mold core comprising at least one main core, the at least one main core being configured to move with respect to the mold core; a first actuator mechanism configured to move the mold core with respect to the mold cavity; the mold core being configured to take a first configuration wherein the at least one main core is in a first position with respect to the mold core to receive the prepreg material; wherein the mold core in the first configuration interacts with the mold cavity with the prepreg material therebetween to form a preform from the prepreg material; the mold core being configured to take a second configuration wherein the at least one main core is in a second position with respect to the mold core; wherein the mold core in the second configuration interacts with the mold cavity with the preform therebetween and further comprises a cavity between the mold core and the mold cavity to receive the injection of the material for over molding onto the preform.

### Example 24

The device according to any one of examples 21 to 23, wherein the mold core comprises the at least one main core and further comprises at least one mold core insert; and wherein the at least one mold core insert being configured to move with respect to the mold core.

### Example 25

The device according to any one of examples 21 to 24, wherein the first configuration further comprises the at least one mold core insert being in a first position with respect to the mold core to receive the prepreg material; and wherein the second configuration further comprises the at least one mold core insert being in a second position with respect to the mold core.

### Example 26

The device according to any one of examples 21 to 25, further comprising at least one second actuator mechanism configured to move at least one of the following: the at least one mold core insert with respect to the mold core and the at least one main core with respect to the mold core.

### Example 27

The device according to any one of examples 21 to 26, further comprising at least one constraining mechanism configured to hold the prepreg material with respect to the mold cavity.

### Example 28

The device according to any one of examples 21 to 27, wherein the at least one mold core insert is arranged along a periphery of the at least one main core.

### Example 29

The device according to any one of examples 21 to 28, wherein the at least one mold core insert is arranged in the at least one main core.

### Example 30

The device according to any one of examples 21 to 29, wherein the at least one mold core insert is arranged along a periphery of the at least one main core; and wherein another at least one mold core insert is arranged in the at least one main core.

### Example 31

The device according to any one of examples 21 to 30, wherein the at least one mold core insert comprises a textured surface.

### Example 32

The device according to any one of examples 21 to 31, wherein the at least one main core comprises a textured surface.

### Example 33

The device according to any one of examples 21 to 32, further comprising a heating device configured to heat at least one of the following: the mold core, the at least one mold core insert, the at least one main core, and the mold cavity.

### Example 34

The device according to any one of examples 21 to 33, wherein the heating device is configured to selectively heat the at least one mold core insert.

### Example 35

The device according to any one of examples 21 to 34, further comprising at least one injector pin configured to inject the material arranged on at least one of the following: the mold core and the mold cavity.

### Example 36

The device according to any one of examples 21 to 35, wherein the at least one injector pin further comprises a piercing structure configured to pierce and hold the prepreg material.

### Example 37

The device according to any one of examples 21 to 36, wherein the at least one constraining mechanism comprising at least one of the following: a vacuum actuator, a support, and a roller.

### Example 38

The device according to any one of examples 21 to 37, wherein the at least one constraining mechanism comprises a vacuum actuator arranged in the at least one mold core insert.

### Example 39

The device according to any one of examples 21 to 38, wherein the mold cavity comprises structure to engage locator holes arranged in the prepreg material.

### Example 40

The device according to any one of examples 21 to 39, further comprising a controller configured to control at least one of the following: the at least one constraining mechanism, the heating device, the first actuator mechanism, and the at least one second actuator mechanism.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

1. A process configured to produce a hybrid composite part, comprising:
configuring a mold cavity to receive a prepreg material;
configuring the mold cavity further to receive an injection of material;
providing a mold core comprising at least one main core, the at least one main core being configured to move with respect to the mold core;
moving the mold core with respect to the mold cavity with a first actuator mechanism;
moving the mold core to take a first configuration wherein the at least one main core is in a first position with respect to the mold core to receive the prepreg material;
forming with the mold core in the first configuration a preform from the prepreg material;
moving the mold core to take a second configuration wherein the at least one main core is in a second position with respect to the mold core; and
over molding onto the preform with the injection of material with the mold core in the second configuration such that the mold cavity has the preform therebetween and forms a cavity between the mold core and the mold cavity.

2. The process of claim 1, wherein the mold core comprising the at least one main core further comprises at least one mold core insert; and
wherein the at least one mold core insert being configured to move with respect to the mold core.

3. The process of claim 2,
wherein the first configuration further comprises the at least one mold core insert being in a first position with respect to the mold core to receive the prepreg material; and
wherein the second configuration further comprises the at least one mold core insert being in a second position with respect to the mold core.

4. The process of claim 2, further comprising moving with at least one second actuator mechanism at least one of the following: the at least one mold core insert with respect to the mold core and the at least one main core with respect to the mold core.

5. The process of claim 1, further comprising holding the prepreg material with respect to the mold cavity with at least one constraining mechanism.

6. The process of claim 5, wherein the at least one constraining mechanism comprises at least one of the following: a vacuum actuator, a support, and a roller.

7. The process of claim 2, wherein the at least one mold core insert is arranged along a periphery of the at least one main core.

8. The process of claim 2, wherein the at least one mold core insert is arranged in the at least one main core.

9. The process of claim 2, wherein the at least one mold core insert comprises a textured surface.

10. The process of claim 2, further comprising heating with a heating device configured to heat at least one of the following: the mold core, the at least one mold core insert, the at least one main core, and the mold cavity.

11. A device configured to produce a hybrid composite part, comprising:
a mold cavity configured to receive a prepreg material;
the mold cavity further configured to receive an injection of material;
a mold core comprising at least one main core, the at least one main core being configured to move with respect to the mold core;
a first actuator mechanism configured to move the mold core with respect to the mold cavity;
the mold core being configured to take a first configuration wherein the at least one main core is in a first position with respect to the mold core to receive the prepreg material;
wherein the mold core in the first configuration interacts with the mold cavity with the prepreg material therebetween to form a preform from the prepreg material;
the mold core being configured to take a second configuration wherein the at least one main core is in a second position with respect to the mold core; and
wherein the mold core in the second configuration interacts with the mold cavity with the preform therebetween and further comprises a cavity between the mold core and the mold cavity to receive the injection of material for over molding onto the preform.

12. The device of claim 11, wherein the mold core comprises the at least one main core and further comprises at least one mold core insert; and
wherein the at least one mold core insert being configured to move with respect to the mold core.

13. The device of claim 12,
wherein the first configuration further comprises the at least one mold core insert being in a first position with respect to the mold core to receive the prepreg material; and
wherein the second configuration further comprises the at least one mold core insert being in a second position with respect to the mold core.

14. The device of claim 12, further comprising at least one second actuator mechanism configured to move at least one of the following: the at least one mold core insert with respect to the mold core and the at least one mold core with respect to the mold core.

15. The device of claim 12, further comprising at least one constraining mechanism configured to hold the prepreg material with respect to the mold cavity.

16. The device of claim 15, wherein the at least one constraining mechanism comprising at least one of the following: a vacuum actuator, a support, and a roller.

17. The device of claim 12, wherein the at least one mold core insert is arranged along a periphery of the at least one main core.

18. The device of claim 12, wherein the at least one mold core insert is arranged in the at least one main core.

19. The device of claim 12, wherein the at least one mold core insert comprises a textured surface.

20. The device of claim 12, further comprising a heating device configured to heat at least one of the following: the mold core, the at least one mold core insert, the at least one main core, and the mold cavity.
